(19) United States
(12) Patent Application Publication
(10) Pub. No.: US 2012/0319035 A1
(43) Pub. Date: Dec. 20, 2012

(54) PRODUCING OXIDIC COMPOUNDS

(75) Inventors: Jordan Keith Lampert, Ludwigshafen (DE); Kirill Bramnik, Jersey City, NJ (US); Joerg Heilek, Bammental (DE)

(73) Assignee: BASF SE, Ludwigshafen (DE)

(21) Appl. No.: 13/575,499

(22) PCT Filed: Jan. 28, 2011
(86) PCT No.: PCT/IB2011/050371

§ 371 Date: Jul. 26, 2012

Related U.S. Application Data
(60) Provisional application No. 61/299,356, filed on Jan. 29, 2010.

(30) Foreign Application Priority Data
Jan. 29, 2010 (EP) 10152110.2
Feb. 16, 2010 (EP) 10153684.5

(51) Int. Cl. H01M 4/485; H01M 4/505; H01M 4/525

(52) U.S. Cl. 252/182.1

(57) ABSTRACT

A process for producing oxidic compounds of the general formula (I) LizMxOy (I) wherein M is one or more elements from groups 2 to 12 of the periodic table, more particularly selected from Co, Mn, Ni, Fe, Al, Mg, x is 1 to 2, y is 2 to 4, and z is 0.5 to 1.5, comprises heating mixtures selected from oxides, hydroxides, carbonates and nitrates of Li and of M together to temperatures in the range from 600 to 1200° C. in a reaction vessel performing incomplete rotary motions about one axis.

This patent application claims the benefit of pending U.S. provisional patent application Ser. No. 61/299,356 filed Jan. 29, 2010, incorporated in its entirety herein by reference.

The present invention relates to a process for producing oxidic compounds of the general formula (I)

Li_{z}MₓO_{y} (I)

where

M is one or more elements from groups 2 to 12 of the periodic table, more particularly selected from Co, Mn, Ni, Fe, Al, Mg,

x is from 1 to 2,

y is from 2 to 4, and

z is from 0.5 to 1.5,

which process comprises heating mixtures selected from oxides, hydroxides, carbonates and nitrates of Li and of M together to temperatures in the range from 600 to 1200° C. in a reaction vessel performing incomplete rotary motions about one axis.

Various applications today require oxidic compounds comprising lithium, for example for so-called lithium ion batteries. In lithium ion batteries, charge is transported not by protons in a more or less hydrated form but by lithium ions in a nonaqueous solvent or in a nonaqueous solvent system. Lithium ion batteries comprise two or more electrodes, of which at least one, the cathode, may be fabricated from highly corrosive material. Examples of such materials are mixed oxides and intercalation compounds of lithium oxide.

It is desirable that the electrodes, more particularly the cathodes, are made of a particularly homogeneous material. Existing production processes leave something to be desired in this respect, however.

In existing production processes, suitable powders are mixed with one another and subsequently reacted with one another at high temperatures in the manner of a solid state reaction. However, the search for suitable kilns has hitherto only brought forth solutions that are nonoptimal.

Tunnel kilns and roller kilns are known as such in various versions and comprise several cars or crucibles on which the reactant material to be fired travels through the heated kiln. Kilns of this type can be used to thermally react powders.

DE 10 2007 024 587 recommends a specific version, a multi-compartment kiln, for producing carbon anodes. However, the powder obtained is in many cases observed to have a nonuniform composition. In addition, the residence times in such kilns tend to be long and therefore the capacity and/or the space-time yield is unsatisfactory.

Rotary kilns are further known to be used for reacting pulverulent materials. Rotary kilns, which are generally slightly inclined, generally provide a distinctly better homogenization of the product compared with tunnel kilns and roller kilns, and the space-time yield is better owing to the reduced residence time. In the present case, however, other problems are observed when rotary kilns are used. Lithium-containing mixed oxides are often highly corrosive, which greatly limits the choice of material suitable for the rotary kiln.

With ceramic rotary kilns, which are sufficiently stable to the action of highly corrosive lithium salts, the heat transfer through the ceramic walls in indirect heating is less than optimal. In addition, owing to the nature of their material of construction, ceramic rotary tubes are only fabricatable and operable in comparatively small sizes, and therefore are only suitable for comparatively small production capacities.

Finally, numerous morphologies are observed to give rise to substantial dusting and thus to a broad particle size distribution having an undesirably high proportion of fine dust.

The present invention accordingly has for its object to provide a process suitable for producing lithium-containing oxidic materials useful as cathode materials for lithium ion batteries. The present invention more particularly has for its object to produce such oxidic materials as have a homogeneous composition and thus are very useful for producing electrode materials. The present invention further has for its object to provide pulverulent materials useful for producing lithium ion batteries.

We have found that this object is achieved by the process defined at the beginning, which herein is also referred to as inventive process.

The inventive process has the purpose of producing oxidic compounds. Oxidic compounds in the context of the present invention may comprise mixed oxides, intercalation compounds, sheet oxides, or spinels. Sheet oxides are preferred.

Oxidic compounds obtained according to the present invention have the general formula (I)

Li_{z}MₓO_{y} (I)

where

M is one or more transition metals or elements of groups 2 to 12 of the periodic table, preferably Mg, Al or elements of groups 5 to 10 of the periodic table, more preferably selected from Co, Mn, Ni, Fe, Al, Mg. M can be present in the oxidation states +1 to +4, preference being given to the oxidation states +2 and +3, and it is particularly preferable to have the oxidation state +3 in the case of Al and the oxidation state +2 in the case of Co, Mn, Ni, Fe, and Mg.

In oxidic compound of formula (I), M can represent combinations of two or more metals, for example combinations of Co and Mn or combinations of Ni and Mn. Other illustrative combinations are Ni, Co, Al, and Ni, Co, Mn. The metals mentioned can be present therein in identical or different molar fractions. In one embodiment of the present invention, M represents Ni, Co, Mn in respectively identical molar fractions.

In another embodiment of the present invention, M represents Ni_{0.6}Co_{0.2}Mn_{0.2}. In another embodiment of the present invention, M represents Ni_{0.5}Co_{0.2}Mn_{0.3}. In another embodiment of the present invention, M represents Ni_{0.4}Co_{0.2}Mn_{0.4}.

In another embodiment of the present invention, M is selected from Ni_{0.4}Co_{0.3}Mn_{0.3}, Ni_{0.45}Co_{0.1}Mn_{0.45}, Ni_{0.4}Co_{0.1}Mn_{0.5} and Ni_{0.5}Co_{0.1}Mn_{0.4}.

x is a number from 1 to 2, can be an average value and is not restricted to integers. Preferably x is 1.

y is a number from 2 to 4, can be an average value and is not restricted to integers. Preferably y is 2+(x−1)+(z−1).

z is a number from 0.5 to 1.5 and preferably from 0.75 to 1.4.

The inventive process proceeds from mixtures of oxides, hydroxides, carbonates and nitrates of lithium and of M, i.e., the transition metal or metals, with at least one lithium compound. The oxide(s), hydroxide(s), carbonate(s) or nitrate(s) of M on the one hand and the lithium compound on the other can have identical or different counter-ions, based on M and lithium.

In one embodiment of the present invention, oxides, carbonates, hydroxides and nitrates of M comprise stoichiometrically unitary compounds.

In another embodiment of the present invention, oxides, carbonates, hydroxides and nitrates of M comprise stoichiometrically nonunitary compounds. Basic carbonates, oxide hydroxides for example of the formula MOOH, basic hydroxides and basic nitrates are suitable for example.

It is further possible for hydroxides, oxides, carbonates and/or nitrates of M and also of lithium to be present in solvated, more particularly hydrated, form or in nonsolvated or nonhydrated form.

Prior to the actual reaction, oxides, hydroxides, carbonates and/or nitrates of lithium and of M are mixed with one another and the desired stoichiometric ratio of M and Li is established in the course of mixing.

The inventive process is carried out in a reaction vessel that is preferably essentially tube-shaped although its shape can be chosen within wide limits.

“Essentially tube-shaped” in the context of the present invention is to be understood as meaning that the length of the reaction vessel in question is distinctly greater than the average diameter as measured at the cross section, and that the cross section is essentially the same along the length of the reaction vessel.

In one embodiment of the present invention, the cross section of the reaction vessel used is circle shaped.

In another embodiment of the present invention, the cross section of the reaction vessel used differs from the circle shape and comprises for example a polygon having rounded corners, for example a rectangle or an equilateral or nonequilateral penta- or hexagon having respectively rounded corners in that one or more of the corners can be rounded in each case.

In another embodiment of the present invention, the cross section of the reaction vessel used in the inventive process is elliptical.

In one embodiment of the present invention, the reaction vessel is from 2 to 200 m, preferably from 3 to 100 m and more preferably from 5 to 50 m in length.

In one embodiment of the present invention, the reaction vessel has an average cross-sectional diameter in the range from 200 to 10 000 mm, preferably in the range from 300 to 5000 mm and more preferably in the range from 500 to 4000 mm. The average diameter in the case of noncircular cross sections is the so-called hydraulic diameter of the cross section, which computes as the ratio (4 times cross section)/(circumference of cross section).

In one embodiment of the present invention, the reaction vessel has a ratio of length to average or hydraulic diameter in the range from 50:1 to 2:1, preferably in the range from 30:1 to 4:1 and more preferably in the range from 20:1 to 7:1.

In the practice of the inventive process, the reaction vessel performs incomplete rotary motions about one axis, preferably about the longitudinal axis.

Incomplete rotary motions comprise continuous incomplete rotary motions in one embodiment of the present invention and discontinuous incomplete rotary motions in another embodiment of the present invention.

“Incomplete rotary motions” in the context of the present invention is to be understood as meaning that the rotary motions amount to rotation of less than 360° but not to rotation by 360°. The extent of the rotary motions can be characterized for example by the field of traverse of the incomplete rotary motion. In one embodiment of the present invention, the field of traverse of the incomplete rotary motion is in the range from 40 to 300°, preferably in the range from 60 to 250° and more preferably in the range from 80 to 180°. It is very particularly preferable for the field of traverse of the incomplete rotary motion to be in the range from 90 to 130°. The field of traverse of the incomplete rotary motion may preferably be determined between the two end deflections (points of reversal) of the rotary motion.

In one embodiment, the reaction vessel performs oscillating or rocking rotary motions.

In one embodiment of the present invention, the reaction vessel performs the oscillating rotary motion at a frequency of 0.1 to 100 pendulum motions per minute, preferably at 1 to 50 pendulum motions per minute and more preferably at 2 to 15 pendulum motions per minute. One pendulum motion describes the to and fro movement until the same position is traversed in the same direction of motion, for example from one end deflection into the other and back again.

The inventive process is carried out by heating to reaction temperatures in the range from 600 to 1200° C. and preferably from 650 to 1050° C. Said heating can be effected directly or indirectly or through combinations of direct and indirect heating. Temperatures preferably relate to the maximum temperature and more particularly to the temperature which can be measured in the gas space above and in the vicinity of the reaction mixture.

In one embodiment of the present invention, the temperature within the reaction vessel is the same or essentially the same, i.e., maximum temperature and minimum temperature differ by 25° C. at most. In another embodiment of the present invention, the reaction vessel has a temperature profile where maximum temperature and minimum temperature can differ by up to 500° C. and preferably by up to 250° C.

In one embodiment of the present invention, the axis about which the above-described incomplete rotary motions are performed and thus the reaction vessel has an inclination in the range from 1 to 20° relative to the horizontal plane, preferably 2 to 10° and more preferably to 7°.

In one embodiment of the present invention, the reaction vessel comprises a pendulum kiln. Pendulum kilns are known as such and for example in EP 0 985 642 A.

In one embodiment of the present invention, the inventive process is performed in an oxygen-containing atmosphere, for example air, or in an oxygen-enriched atmosphere. In one embodiment of the present invention, the inventive process is performed in an oxygen atmosphere comprising merely volatile reaction products as well as oxygen.

In one embodiment of the present invention, speed and extent of incomplete rotary motions on the one hand and the inclination of the reaction vessel on the other are adjusted such that the average residence time of the mixture in the reaction vessel is in the range from half an hour up to 15 hours and preferably in the range from one to 10 hours. The extent of incomplete rotary motions and the inclination of the reaction vessel are adapted as a function of the resulting movement characteristics of the mixture.

The reaction vessel is preferably operated in a steady state.

In one embodiment of the present invention, the reaction vessel includes an inlet housing and an outlet housing or discharge housing, which are preferably positioned essentially opposite each other at the respective ends of the reaction space.

One embodiment of the present invention utilizes mixture of oxides selected from oxides, hydroxides, carbonates and nitrates of Li and of M in pulverulent or pasty form.

To use the mixture of oxides selected from oxides, hydroxides, carbonates and nitrates of Li and of M in pasty form, the paste can be prepared with water or an alcohol. Useful alcohols include for example C₁-C₄ alkanols, more particularly ethanol, or polyethylene glycol, for example having an average molecular weight M_{w} in the range from 500 to 2000 g/mol. A suitable paste can have for example a solids content in the range from 20% to 95% by weight and preferably in the range from 40% to 90% by weight. The alcohol can undergo combustion under the reaction conditions, in which case it is preferable to use an oxygen-enriched atmosphere to ensure complete combustion.

In one embodiment of the present invention, the inventive process involves at least one of the following reactions:

2 LiOH.H₂O+2 M(OH)₂+½ O₂→2 LiMO₂+5 H₂O

Li₂CO₃+2 M(OH)₂+½ O₂→2 LiMO₂+2 H₂O+CO₂

LiNO₃+M(OH)₂→LiMO₂+NO₂+H₂O

Instead of M(OH)₂, MO·aq can be used to carry out the aforementioned reactions.

In one embodiment, by-products which are gaseous under the reaction conditions such as for example water, CO₂ and nitrogen oxides such as NO₂ for example are withdrawn from the reaction vessel in a continuous manner. In another embodiment of the present invention, by-products which are gaseous under the reaction conditions can be withdrawn from the reaction vessel in intervals.

It is naturally preferable to clean up the stream of by-products which are gaseous under the reaction conditions and optionally to effect measures for exit gas cleaning or waste heat recovery. Exit gas cleaning can be necessary particularly when nitrates are used on a comparatively large scale. Exit gas cleaning can comprise for example an NOₓ decomposition and/or a removal of dust.

One embodiment of the present invention utilizes a reaction vessel consisting essentially of one or more ceramic materials of construction or lined, for example brickworked, with ceramic material.

One embodiment of the present invention may utilize a reaction vessel at least partially lined with ceramic tiles or ceramic bricks, for example with ceramic tiles or ceramic bricks based on Al₂O₃ or based on MgO-doped Al₂O₃.

One embodiment of the present invention may comprise direct heating of the reaction vessel, for example through one or more burners which are each installed on the inside surface of the reaction vessel and which may each comprise for example a radiant electric heater or a combination of two or more radiant electric heaters. Burners operated with gas, preferably with natural gas, can be used in one version.

The inventive process provides oxidic compound of unitary chemical composition and preferably narrow particle diameter distribution. The oxidic compounds obtained according to the present invention are therefore very useful in the manufacture of electrodes, for example anodes or cathodes, for lithium ion batteries. The oxidic compounds obtained according to the present invention therefore generally comprise only a very low level of undesired impurities from the wall material of the reaction vessel.

In addition, the oxidic compounds obtained by the inventive process are obtainable with high space-time yields and with high capacities.

1. A process for producing an oxidic compound having a formula (I)
Li_{z}MₓO_{y} (I)
where
M is one or more elements from groups 2 to 12 of the periodic table,
x is from 1 to 2,
y is from 2 to 4, and
z is from 0.5 to 1.5,
the process comprising heating a mixture comprising a) an oxide, hydroxide, carbonate or nitrate of Li and b) an oxide, hydroxide, carbonate or nitrate of M together to a temperature of 600 to 1200° C. in a reaction vessel performing an incomplete rotary motion about one axis.

2. The process of claim 1, wherein the axis about which the incomplete rotary motion is performed has an inclination of 1 to 20° relative to a horizontal plane.

3. The process of claim 1, wherein the reaction vessel comprises a pendulum kiln.

4. The process of claim 1, wherein the reaction vessel has an inclination of 1 to 20°.

5. The process of claim 1, performed in an atmosphere comprising oxygen.

6. The process of claim 1, wherein a) and b) are in pulverulent or pasty form.

7. The process of claim 6, wherein a) and b) are in pasty form, wherein a paste is prepared with water or an alcohol.

8. The process of claim 1, wherein a field of traverse of the incomplete rotary motion is 60 to 250°.

9. The process of claim 1, wherein the heating comprises direct heating.

10. The process of claim 1, wherein M is at least one element selected from Co, Mn, Ni, Fe, Al and Mg.

11. The process of claim 1, wherein x is 1.

12. The process of claim 1, wherein y is 2+(x−1)+(z−1).

13. The process of claim 1, wherein z is 0.75 to 1.4.

14. The process of claim 1, wherein x is 1, y is 2+(x−1)+(z−1), and z is 0.75 to 1.4.

15. The process of claim 1, wherein M is a combination of Ni, Co and Mn selected from the group consisting of Ni_{0.33}Co_{0.33}Mn_{0.33}, Ni_{0.6}Co_{0.2}Mn_{0.2}, Ni_{0.5}Co_{0.2}Mn_{0.3}, Ni_{0.4}Co_{0.2}Mn_{0.4}, Ni_{0.4}Co_{0.3}Mn_{0.3}, Ni_{0.45}Co_{0.1}Mn_{0.45}, Ni_{0.4}Co_{0.1}Mn_{0.5} and Ni_{0.5}Co_{0.1}Mn_{0.4}.

16. The process of claim 1, wherein the reaction vessel has a length of 2 to 200 m.

17. The process of claim 1, wherein the reaction vessel has an average cross-sectional diameter of 200 to 10 000 mm.

18. The process of claim 1, wherein the reaction vessel has a ratio of length to average cross-sectional diameter in a range of 50:1 to 2:1.

19. The process of claim 1, wherein the incomplete rotary motion is performed in an oscillatory manner, at a frequency of 0.1 to 100 pendulum motions per minute.

20. The process of claim 1, comprising heating the mixture to the temperature of 650 to 1050° C.
